(19) United States
(12) Patent Application Publication
(10) Pub. No.: US 2025/0233813 A1
(43) Pub. Date: Jul. 17, 2025

(54) WIRELESS COMMUNICATION METHOD AND CONTROLLER THEREOF

(71) Applicant: MEDIATEK INC., Hsinchu City (TW)

(72) Inventors: Chun-Tse Lin, Hsinchu City (TW); Hung-Wen Yang, Hsinchu City (TW); Chia-Hsiang Chang, Hsinchu City (TW)

(21) Appl. No.: 19/004,549

(22) Filed: Dec. 30, 2024

Related U.S. Application Data
(60) Provisional application No. 63/621,196, filed on Jan. 16, 2024.

(51) Int. Cl. H04L 43/0811; H04L 43/062

(52) U.S. Cl. CPC H04L 43/0811; H04L 43/062

(57) ABSTRACT

A wireless communication method and system are disclosed. After a station is wireless connected to an agent, the agent monitors airtime of each link of the station to report a first link status to a controller. The controller collects the first link status and detects scenarios based on the first link status. The controller determines to select among an initial second link and a candidate second link status as a second link status based on whether a throughput of the candidate second link status is higher than a throughput of first link status. The controller informs the second link status to the agent, and the controller wireless communicates with the agent over bands corresponding to the second link status.

This application claims the benefit of U.S. Provisional Patent application Ser. No. 63/621,196, filed 2024 Jan. 16, the disclosure of which is incorporated by reference herein in its entirety.

### TECHNICAL FIELD

The disclosure relates to a wireless communication method and controller thereof.

### BACKGROUND

In a Wi-Fi mesh network, the backhaul (BH) and fronthaul (FH) share the same communication channel, meaning they use the same frequency band and compete for the available channel airtime. This has significant implications. Since both BH and FH operate on the same channel, BH and FH must alternate their transmissions to avoid interference. This limits the effective throughput and can result in reduced overall network performance, especially in high-demand environments.

Wi-Fi 6 mesh routers come with different capabilities, particularly regarding how they handle the BH. Based on these capabilities, these routers may be categorized into three types: (1) Shared BH; (2) Faster BH; and (3) Dedicated BH. In Shared BH type, most of the current Wifi6 stations (STAs) only have the capability of BW80 (80 MHz bandwidth), therefore the bandwidth of BH will overlap with FH. In Faster BH type, Wifi6 5G Channel supports BW160 (160 MHz bandwidth), larger bandwidth implies higher throughput. In Dedicated BH type, Wifi6E has started to support the use of 6G Channel, compared to FH STA which mostly use 2G and 5G Channel, having a Dedicated 6G BH not only avoids competition with FH, but also has a higher throughput.

By analyzing the specifications of commercially available Wi-Fi 6 mesh routers, this classification helps users and network designers select the appropriate product type based on their needs, such as maximizing speed, minimizing interference, or optimizing for cost.

Wifi6E begins to support the use of 6G channels, by adding a dedicated 6G BH to avoid competition with most FH STAs using 2G and 5G Channels.

The new technology MLO (Multi-link Operation) in Wifi7 allows devices to have multiple link connections, thus the 6G channel is used more widely. How to cleverly choose the BH Link to avoid competition with FH is a new topic.

Thus, the application discloses a wireless communication method and controller thereof which propose a backhaul link adaption mechanism to enhance the overall throughput of the mesh network.

### SUMMARY

According to one embodiment, provided is a controller, used in a wireless communication system comprising a station, the controller being configured to: collect a first link status and detect scenarios based on the first link status, the first link status being indicative of airtime of links of the station; determine among an initial second link and a candidate second link status as a second link status based on whether a throughput of the candidate second link status is higher than a throughput of first link status; and inform an agent, wirelessly communicated with the controller, the second link status.

According to another embodiment, a wireless communication method is provided. The wireless communication method comprises: collecting a first link status and detect scenarios based on the first link status, the first link status being indicative of airtime of links of a station of a wireless communication system; determining among an initial second link and a candidate second link status as a second link status based on whether a throughput of the candidate second link status is higher than a throughput of first link status; and informing an agent, wirelessly communicated with a controller of the wireless communication system, the second link status.

### BRIEF DESCRIPTION OF THE DRAWINGS

FIG. 1 shows a wireless communication system according to one embodiment of the application.

FIG. 2A and FIG. 2B show a wireless communication method according to one embodiment of the application.

FIG. 3 shows a wireless communication method according to one embodiment of the application.

FIG. 4A shows an example of a network topology used in backhaul link adaption mechanism evaluation in the application.

FIG. 4B to FIG. 4D show several examples of backhaul link adaption mechanism evaluation results in the application.

FIG. 5 shows a wireless communication method according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

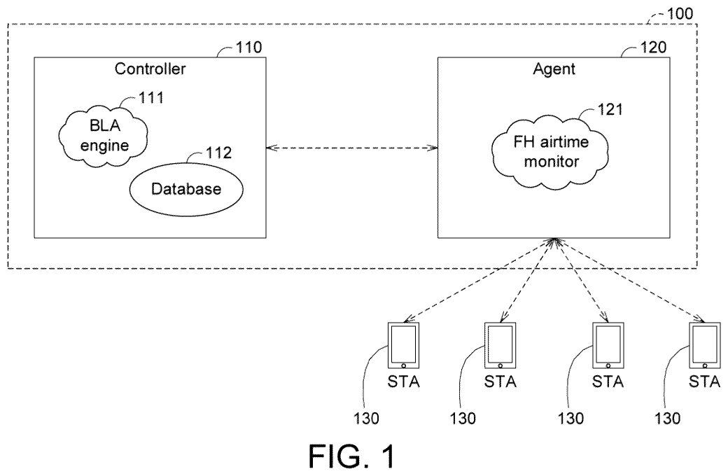

FIG. 1 shows a wireless communication system according to one embodiment of the application. The wireless communication system 100 according to one embodiment of the application includes a controller 110 (or said a master device, a controlling device) and at least one agent 120 (or said agent device). The controller 110 and the agent 120 are for example but not limited by, Wi-Fi routers or the like. The controller 110 and the agent 120 are wireless communicating with each other. The agent 120 may have wireless communication between at least one station 130. The station 130 may support 2G and/or 5G and/or 6G channels. The station 130 may be for example but not limited by, user devices having Wi-Fi communication functions.

The controller 110 includes a BLA (backhaul link adaption) engine 111 and a database 112. The database 112 is used to store the airtime of each link of the stations 130, reported from the agent 120; and transmits the airtime of each link of the stations 130 to the BLA engine 111. The BLA engine 111 detects scenarios based on the airtime of each link of the stations 130 from the database 112; and executes the BLA mechanism and selects BH links based on scenarios detection result. The BLA engine 111 also informs the agent about the selected BH links.

The agent 120 includes a FH (fronthaul) airtime monitor unit 121. The FH airtime monitor unit 121 performs FH airtime monitor to monitor the airtime of each link of the stations 130 and reports back to the BLA engine 111 of the controller 110. Also, after informed by the controller 110, the agent 120 communicates with the controller 110 over the selected BH links which is selected by the controller 110.

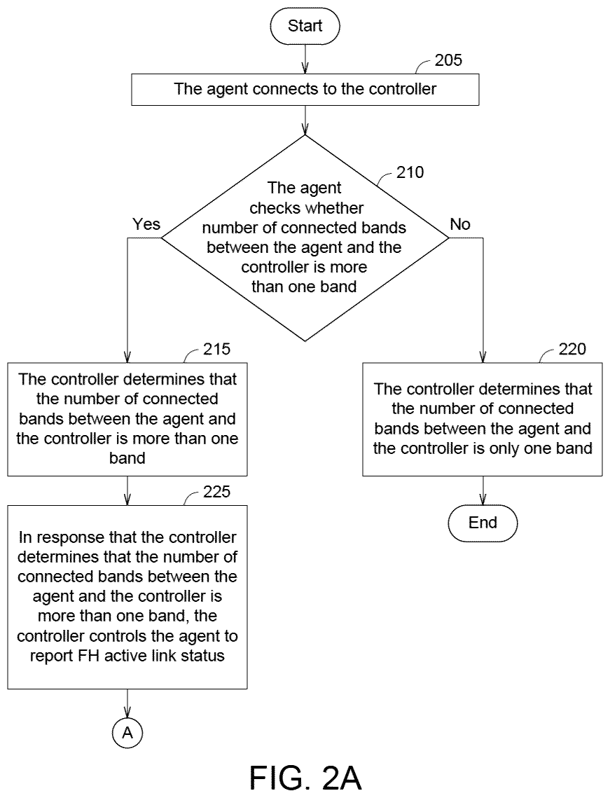

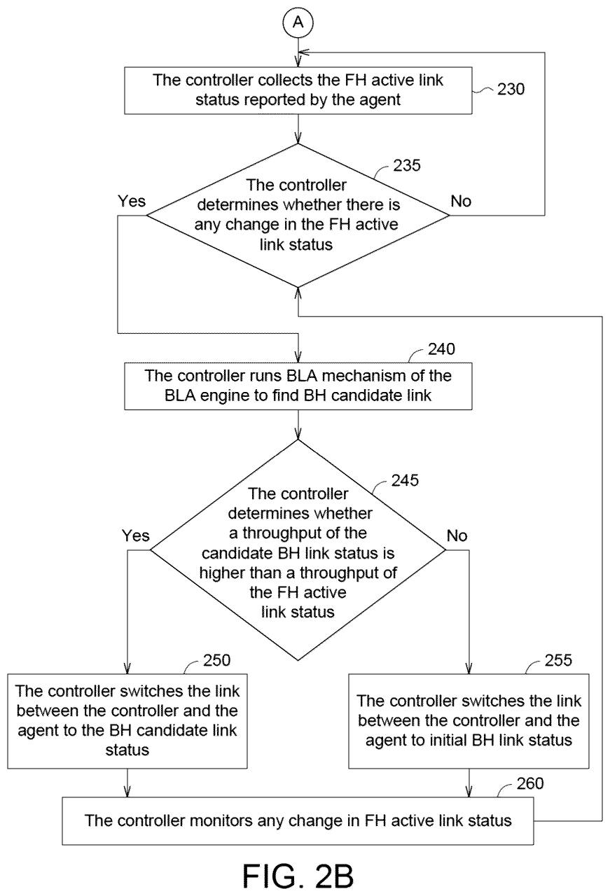

FIG. 2A and FIG. 2B show a wireless communication method according to one embodiment of the application. In step 205, the agent 120 connects to the controller 110. In step 210, the agent 120 checks whether number of connected bands between the agent 120 and the controller 110 is more than one band.

In step 215, the controller 110 determines that the number of connected bands between the agent 120 and the controller 110 is more than one band. After step 215, the flow proceeds to step 225.

In step 220, the controller 110 determines that the number of connected bands between the agent 120 and the controller 110 is only one band. After step 220, the flow ends.

In step 225, in response that the controller 110 determines that the number of connected bands between the agent 120 and the controller 110 is more than one band, the controller 110 controls the agent 120 to report FH active link status.

In step 230, the controller 110 collects the FH active link status reported by the agent 120.

In step 235, the controller 110 determines whether there is any change in the FH active link status. If step 235 is yes, the flow proceeds to step 240. In step 235 is no, the flow returns to step 230.

In step 240, the controller 110 runs BLA mechanism of the BLA engine 111 to find BH candidate link.

In step 245, the controller 110 determines whether a throughput of the candidate BH link status is higher than a throughput of the FH active link status.

If step 245 is yes, the flow proceeds to step 250. In step 250, the controller 110 switches the link between the controller 110 and the agent 120 to the BH candidate link status. In step 245 is no, the flow proceeds to step 255. In step 255, the controller 110 switches the link between the controller 110 and the agent 120 to initial BH link status. Definition of the “initial BH link status” will be described later.

After steps 250 and 255, the controller 110 monitors any change in FH active link status in step 260. After step 260, the flow returns to step 235.

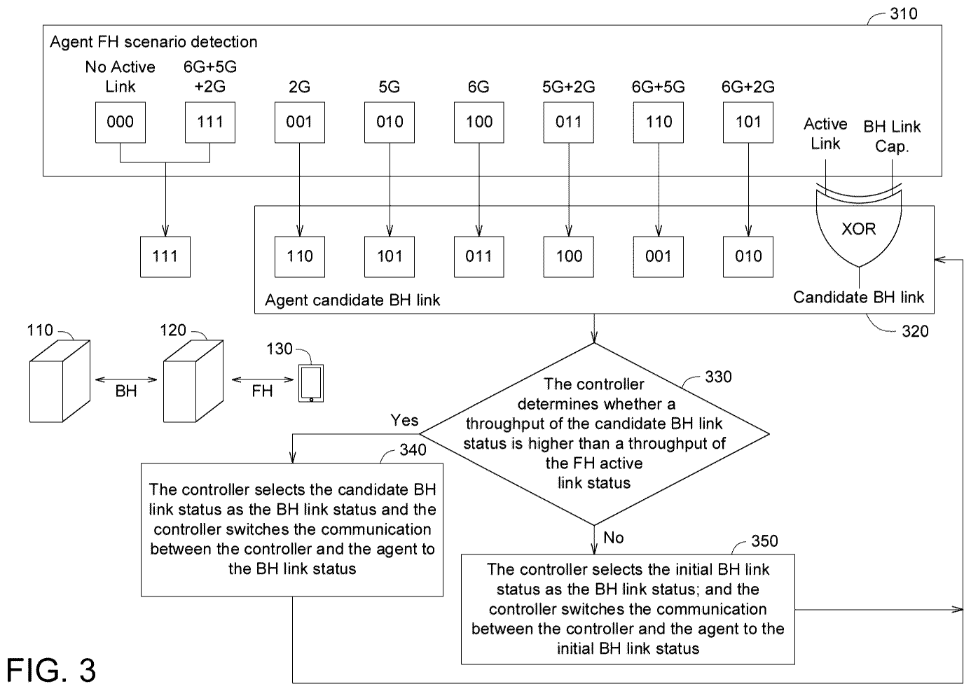

FIG. 3 shows a wireless communication method according to one embodiment of the application. In step 310, the agent 120 performs FH airtime monitor to monitor the airtime of each link of the stations 130 and reports the FH active link status back to the BLA engine 111 of the controller 110. That is, in step 310, the agent 120 detects FH active link status. The FH active link status refers to the active link between the agent 120 and the station(s) 130.

In FIG. 3, for example but not limited by, the FH active link status between the station 130 and the agent 120 defines one combination among any combination of 2G band, 5G band and 6G band. In FIG. 3, the FH active link status “000” refers that there is no any active band used in the FH active link (or said “no active link”); the FH active link status “111” indicates that the combination of 6G band, 5G band and 2G band is used as the FH active link between the agent 120 and the station 130 (which means that the agent 120 and the station 130 communicates with each other over the combination of 6G band, 5G band and 2G band); the FH active link status “001” refers that the combination of only 2G band is used as the FH active link (which means that the agent 120 and the station 130 communicates with each other over 2G band). Others are so on.

In step 320, based on the FH active link status reported from the agent 120, the controller 110 determines the candidate BH link status by running the BLA engine 111. For example, the BLA engine 111 generates the candidate BH link status by XORing the active FH link status and the BH link capability. The BH link capability, which is “111”, indicates a combination of all usable BH bands, i.e. the combination of 6G band, 5G band and 2G band, for example but not limited by. For example, if the FH active link status is “001”, then the candidate BH link status “110” is generated by XORing the FH active link status (“001”) and the BH link capability (“111”). Others are so on.

Table 1 shows the FH active link status, the FH band combination, the candidate BH link status and the BH band combination in one possible example of the application. The candidate BH link status and the BH band combination are corresponding. The candidate BH link status defines the BH band combination. Similarly, if the candidate BH link status is “110”, the BH band combination is combination of 6G band and 5G band. Others are so on. 10

TABLE 1

| the FH active | The FH band | the candidate | the BH band |
|---|---|---|---|
| link status | combination | BH link status | combination |
| 001 | Combination of | 110 | Combination of |
| | only 2G band | | 6G band and 5G |
| | | | band |
| 010 | Combination of | 101 | Combination of |
| | only 5G band | | 6G band and 2G |
| | | | band |
| 100 | Combination of | 011 | Combination of |
| | only 6G band | | 5G band and 2G |
| | | | band |
| 011 | Combination of | 100 | Combination of |
| | 5G band and 2G | | only 6G band |
| | band | | |
| 110 | Combination of | 001 | Combination of |
| | 6G band and 5G | | only 2G band |
| | band | | |
| 101 | Combination of | 010 | Combination of |
| | 6G band and 2G | | only 5G band |
| | band | | |

In table 1, special case is that when the FH active link status is “000” or “111”, the controller 110 determines that the candidate BH link status is “111” (which means the BH band selections are combination of 6G band, 5G band and 2G band).

In step 330, the controller 110 determines whether a throughput of the candidate BH link status is higher than a throughput of the FH active link status, the same or similar to step 245 of FIG. 2B.

In more details, in step 330, for example but not limited by, when the candidate BH link status is “110” (which means the BH band selections are combination of 6G band, 5G band), the 6G band has a bandwidth of BW320 (320 MHz) and the 5G band has a bandwidth of BW160 (160 MHz). Thus, a throughput of the candidate BH link status “110” is equal to 320 MHz+160 MHz=480 MHz. The candidate BH link status “110” is corresponding to the FH active link status “001” (which means the FH band selections are combination of only 2G band), and the 2G band has a bandwidth of BW40 (40 MHz). Thus, a throughput of the FH active link status “001” is equal to 40 MHz. In step 330, the controller 110 determines that a throughput (480 MHz) of the candidate BH link status (“110”) is higher than a throughput (40 MHz) of the FH active link status (“001”).

On the other hand, in step 330, for example but not limited by, when the candidate BH link status is “001” (which means the BH band selections are combination of only 2G band), the 2G band has a bandwidth of BW40 (40 MHZ). Thus, a throughput of the candidate BH link status “001” is equal to 40 MHz. The candidate BH link status “001” is corresponding to the FH active link status “110” (which means the FH band selections are combination of 6G band and 5G band), the 6G band has a bandwidth of BW320 (320 MHz) and the 5G band a bandwidth of BW160 (160 MHz). Thus, a throughput of the FH active link status “110” is equal to 320+160=480 MHz. In step 330, the controller 110 determines that a throughput (40 MHz) of the candidate BH link status (“001”) is lower than a throughput (480 MHZ) of the FH active link status (“110”).

If yes in step 330, in step 340, the controller selects the candidate BH link status as the BH link status and the controller 110 switches the communication between the controller 110 and the agent 120 to the BH link status (that is, the link between the controller 110 and the agent 120 is over the BH band selected based on the BH link status), the same or similar to step 250 of FIG. 2B.

If no in step 330, in step 350, the controller selects the initial BH link status as the BH link status; and the controller 110 switches the communication between the controller 110 and the agent 120 to the initial BH link status, the same or similar to step 255 of FIG. 2B. Here, the initial BH link status refers combination of 6G band, 5G band and 2G band. That is, the controller 110 selects one among the initial BH link status and the candidate BH link status as the BH link status based on whether a throughput of the candidate BH link status is higher than a throughput of the FH active link status. After selection of the BH link status, the controller 110 informs the BH link status to the agent 120.

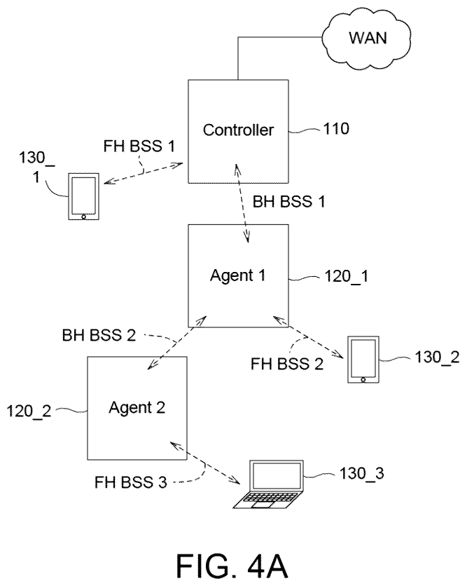

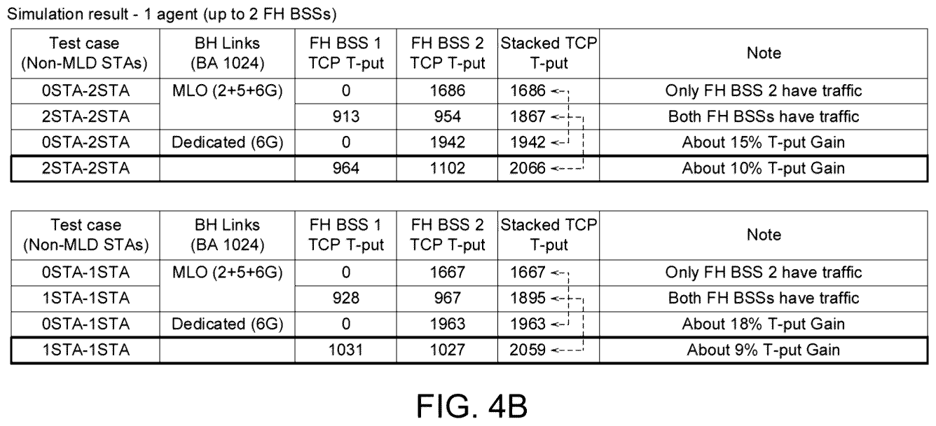

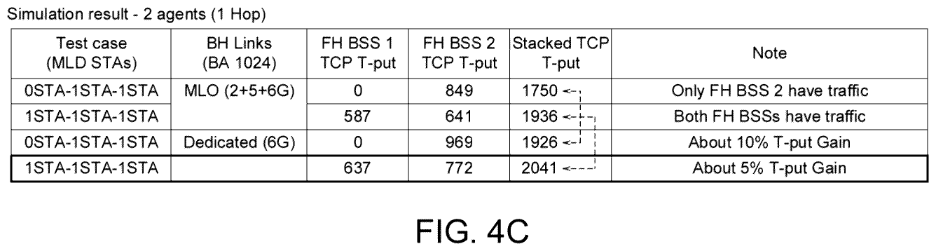

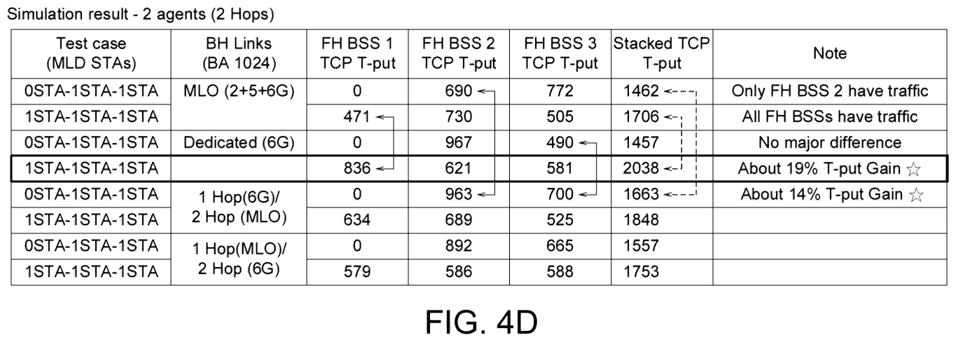

FIG. 4A shows an example of a network topology used in backhaul link adaption mechanism evaluation in the application. As shown in FIG. 4A, the controller 110 connects to the agent 120_1 and the station 130_1. The agent 120_1 connects to the agent 120_2 and the station 130_2. The agent 120_2 connects to the station 130_3. The controller 110 and the agent 120_1 are in the BH BSS1 (BSS refers to Basic Service Set) and others are so on.

FIG. 4B to FIG. 4D show several examples of backhaul link adaption mechanism evaluation results in the application.

FIG. 4B shows the simulation result in one agent up to 2HF BBS. In the test case (Non MLO Device (MLD) station case), compared with MLO (2G+5G+6G) 0A0B-2A0B, having 1686 stacked TCP throughput (T-put), the dedicated BH types 0A0B-2A0B having 1942 stacked TCP t-put, thus there is about 15% throughput (T-put) gain. Similarly, in the test case (MLD station case), compared with MLO (2G+5G+6G), the dedicated BH type has about 18% or 9% throughput (T-put) gain.

FIG. 4C shows the simulation result in two agents (1-hop). In the test case (MLD station case), compared with MLO (2G+5G+6G), the dedicated BH type has about 10% or 5% throughput (T-put) gain.

FIG. 4D shows the simulation result in two agents (2-hop). In the test case (MLD station case), compared with MLO (2G+5G+6G), the dedicated BH type has about 19% or 14% throughput (T-put) gain.

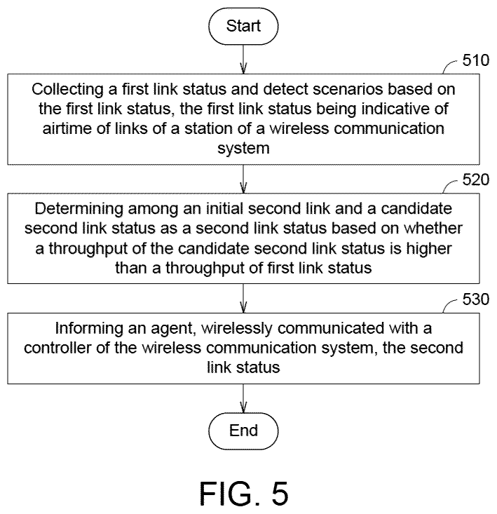

FIG. 5 shows a wireless communication method according to one embodiment of the application. The wireless communication method according to one embodiment of the application includes: (510) collecting a first link status and detect scenarios based on the first link status, the first link status being indicative of airtime of links of a station of a wireless communication system; (520) determining among an initial second link and a candidate second link status as a second link status based on whether a throughput of the candidate second link status is higher than a throughput of first link status; and (530) informing an agent, wirelessly communicated with a controller of the wireless communication system, the second link status.

In one embodiment of the application, by detecting the airtime of HF station on different bands, BH links are dynamically selected.

In the application, the proposed backhaul link adaption mechanism comprises a FH airtime monitor (of the agent) and a BLA engine (of the controller). One of the features of the application is that the selection of BH Link is based on the airtime usage of different links by FH stations. Also, the application addresses to Wi-Fi generations after Wi-Fi 5, including Wi-Fi 5, Wi-Fi 6E, Wi-Fi 7, Wi-Fi 8, etc.

The above primarily describes the solutions provided in the embodiments of the present application from the perspective of backhaul link adaption. It is understood that to achieve the above functions, the controller and/or the agent of the wireless communication system includes corresponding hardware structures and/or software modules that execute functions. One skilled person in the technical field can easily recognize that the units and algorithm steps described in the embodiments of the present application can be implemented in hardware form or a combination of hardware and computer software. Whether the functions are performed by hardware or by hardware driven by computer software depends on the specific application and design constraints of the technical solution. One skilled person in the technical field can use different methods to implement the functions described in each specific application without departing from the scope of the present application.

In one embodiment of the present application, the controller and/or the agent of the wireless communication system can be divided into functional modules based on the aforementioned method examples. For instance, each functional module can be obtained by dividing according to each corresponding function, or two or more functions can be integrated into one processing module. The integrated module can be implemented in hardware form or as a software functional module. It should be noted that in the embodiments of the present application, the division into modules is merely an example and is a logical function division. In the actual implementation process, other division methods can be used.

While many specific details have been described in this case, these should not be construed as limitations to the scope of the claimed invention, but rather as descriptions of the characteristics of specific embodiments. Certain characteristics described in the context of a single embodiment may also be implemented in combination in a single embodiment. Conversely, various characteristics described in the context of a single embodiment may be implemented individually or in any suitable sub-combination in multiple embodiments. Moreover, although the characteristics may initially be described as functioning in certain combinations, or even initially illustrated as such, in some cases one or more characteristics may be deleted from the combination, and the described combination may be directed to a sub-combination or a variation of a sub-combination. Similarly, although operations are depicted in the illustrations as occurring in a particular order, this should not be understood as requiring that such operations be performed in the specific order shown or in sequential order, or that all depicted operations must be performed to achieve the desired result.

Although the above-described embodiments disclose some examples and implementations, changes, modifications, and enhancements can be made to the described examples and implementations and other implementations based on the disclosed content.

In summary, although the present invention has been disclosed above with embodiments, it is not intended to limit the present invention. Those skilled in the art to which this invention pertains can make various changes and refinements without departing from the spirit and scope of the invention. Therefore, the scope of protection of the present invention should be defined by the appended claims.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A controller, used in a wireless communication system comprising a station, the controller being configured to:
collect a first link status and detect scenarios based on the first link status, the first link status being indicative of airtime of links of the station;
determine among an initial second link and a candidate second link status as a second link status based on whether a throughput of the candidate second link status is higher than a throughput of first link status; and
inform an agent, wirelessly communicated with the controller, the second link status.

2. The controller according to claim 1, further being configured to determine the candidate second link status based on the first link status and a link capability, the link capability indicating a combination of all usable bands.

3. The controller according to claim 2, wherein
in response that the throughput of the candidate second link status is higher than the throughput of the first link status, the controller is further configured to determine the candidate second link status as the second link status; or
in response that the throughput of the candidate second link status is lower than the throughput of the first link status, the controller is further configured to determine the initial second link status as the second link status, wherein the initial second link status refers combination of all usable bands.

4. The controller according to claim 1, wherein the first link status is collected from the agent which monitors the airtime of the links of the station, and the controller is further configured to wirelessly communicate with the agent over bands which are corresponding to the second link.

5. The controller according to claim 1, wherein
in response that the scenarios detected based on the first link status indicating there is change in the first link status, the controller is further configured to run a backhaul link adaption mechanism to determine the candidate second link status.

6. A wireless communication method comprising:
collecting a first link status and detect scenarios based on the first link status, the first link status being indicative of airtime of links of a station of a wireless communication system;
determining among an initial second link and a candidate second link status as a second link status based on whether a throughput of the candidate second link status is higher than a throughput of first link status; and
informing an agent, wirelessly communicated with a controller of the wireless communication system, the second link status.

7. The wireless communication method according to claim 6, wherein the candidate second link status is determined based on the first link status and a link capability, the link capability indicating a combination of all usable bands.

8. The wireless communication method according to claim 7, wherein
in response that the throughput of the candidate second link status is higher than the throughput of the first link status, the candidate second link status is determined as the second link status; and
in response that the throughput of the candidate second link status is lower than the throughput of the first link status, the initial second link status is determined as the second link status, wherein the initial second link status refers combination of all usable bands.

9. The wireless communication method according to claim 6, wherein the first link status is collected from the agent which monitors the airtime of the links of the station, and the controller wirelessly communicates with the agent over bands which are corresponding to the second link.

10. The wireless communication method according to claim 6, wherein
in response that the scenarios detected based on the first link status indicating there is change in the first link status, running a backhaul link adaption mechanism to determine the candidate second link status.
